(19) United States
(12) Patent Application Publication
(10) Pub. No.: US 2005/0127330 A1
(43) Pub. Date: Jun. 16, 2005

(54) Particles for display device, producing method thereof, image display medium and image forming apparatus

(75) Inventors: Satoshi Hiraoka, Minamiashigara-shi (JP); Hidehiko Soyama, Minamiashigara-shi (JP); Yasuo Yamamoto, Minamiashigara-shi (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/860,159

(22) Filed: Jun. 4, 2004

(30) Foreign Application Priority Data
Dec. 16, 2003 (JP) 2003-417911

(51) Int. Cl. H01C 1/00

(52) U.S. Cl. 252/500

(57) ABSTRACT

Particles for a display device including carbon black having a pH of 3.5 or less and having a property of being able to be charged positively or negatively. The particles are produced by at least mixing and stirring an oil phase solution including the carbon black and a compound containing a nitrogen atom, and an aqueous phase solution.

### CROSS-REFERENCE TO RELATED APPLICATION

This application claims priority under 35USC 119 from Japanese Patent Application No. 2003-41791 1, the disclosure of which is incorporated by reference herein.

### BACKGROUND OF THE INVENTION

1. Field of the Invention

The present invention relates to particles for a display device used for displaying an image, a producing method thereof, a reiteratively writable image display medium using the above-mentioned particles for a display device, and an image forming apparatus using this image display medium.

2. Description of the Related Art

Display technologies such as Twisting Ball Display (display by rotation of particles separately colored with two-colors), electrophoresis, magnetophoresis, thermal rewritable media and liquid crystal having memory property have been conventionally proposed as a reiteratively writable image display medium. The above-mentioned display technologies are superior in memory property of an image. However, they do not allow a screen to be a white display such as paper, and there is a problem in that contrast is low.

On the other hand, the following display technology is proposed on pp. 249-252 in the collected papers of Japan Hardcopy '99 as a display technology using toner for solving the above-mentioned problem. In order to display an image by contrast between electro-conductive color toner and white particles, the electro-conductive color toner and the white particles are sealed between opposing electrode substrates, charge is injected into the electro-conductive color toner through a charge transport layer disposed on an electrode surface of a substrate on the non-display side, the electro-conductive color toner which has undergone the charge injection moves to the display substrate side located so as to be opposed to the non-display substrate due to an electric field between the electrode substrates, and the electro-conductive color toner attaches to the inside of the electrode substrate on the display side.

In this display technology, an image display medium is completely composed of solids, which is superior in that, in principle, a display can be switched between white and black by 100%. In the above-mentioned technology, however, the electro-conductive color toners include electro-conductive color toner that is not adjacent to the charge transport layer disposed on an electrode surface of an electrode substrate on the non-display side and electro-conductive color toner that is isolated from other electro-conductive color toners. Charge is not injected into these electro-conductive color toners, and therefore, they do not move by an electric field and exist between the substrates at random. As a result, there is a problem in that contrast is low.

Japanese Patent Application Laid-Open (JP-A) No. 2001-312225 proposes image display technology utilizing an image display medium including a pair of substrates and plural kinds of particles having different colors and charging properties, which particles are sealed between the substrates so as to be capable of moving therebetween due to an applied electric field. This technology obtains a high whiteness degree; however, it does not obtain a high optical reflection density in the case of displaying a black image.

### SUMMARY OF THE INVENTION

The present invention has been made in view of the above circumstances and provides particles for a display device which can increase optical reflection density in a black image display portion, a producing method thereof, an image display medium using these particles for a display device, and an image forming apparatus.

In order to achieve the foregoing, it is required to control an added quantity and a dispersibility of carbon black substantially utilized as black pigment contained in particles (particles for a display device) used for an image display in an image display medium. That is, in order to increase optical reflection density in a black image display portion, it is required to increase the added quantity of carbon black and improve the dispersibility of black pigment in particles for a display device. However, the added quantity is inevitably limited, so that the improvement of the dispersibility of carbon black is required for an essential solution.

Particles for a display device are frequently produced by utilizing a wet-type producing method such as suspension polymerization for producing spherical particles. Such a granulating method is also frequently employed for producing toner. Conventional toner produced by a wet-type producing method is frequently produced by utilizing carbon black previously coated with vinyl chloride resin and vinyl acetate resin in order to improve the dispersibility of carbon black in the toner.

Accordingly, it is also thought that the utilization of a technology for improving the dispersibility of carbon black, which has been conventionally utilized for producing toner, would allow particles for a display device, such as described above, to be easily achieved. The inventors of the invention, however, have concluded for the reasons described below that it is extremely difficult to merely utilize a technology for improving the dispersibility of carbon black, which has been utilized for producing toner.

That is, optical reflection density of a black image formed by toner into which such carbon black is dispersed can be comparatively easily improved by the improvement of optical reflection density of a coloring unit (toner particles) itself and additionally by utilizing a lamination effect such that an image is formed by laminating a coloring unit (toner particles) on a paper surface. Thus, it is preferred that the improvement of optical reflection density of a coloring unit (toner particles) itself is achieved to a certain extent, and also, the variation of optical reflection density among individual coloring units (toner particles) is allowable to a certain extent for the reason that toner particles are laminated on the occasion of forming an image.

Meanwhile, with regard to an image display medium, a coloring unit (particles for a display device) is arrayed on a display surface substantially in a monolayer state to form an image. Thus, lamination effect can not be utilized in an image display medium, unlike in an image composed of toner; therefore, the improvement of optical reflection density of an individual coloring unit (particles for a display device) itself is further required, and also, it is important to decrease the variation of optical reflection density among coloring units (particles for a display device). That is, it is extremely important that black pigment (carbon black) used for particles for a display device is further superior in dispersibility and also low in variation in dispersibility within an individual coloring unit (particles for a display device).

Consequently, carbon black utilized for particles for a display device requires a superior dispersibility to carbon black that has been utilized in a conventional toner technology, and a stable dispersion state.

Particles for a display device can also be produced by utilizing a dry-type producing method, such as a pulverizing-classifying process, but are preferably produced by utilizing a wet-type producing method such as suspension polymerization in view of easily obtaining spherical particles. In this case, particles for a display device are produced by mixing and stirring an oil phase solution, in which main raw material components such as pigment and resin composing the particles for a display device are dispersed and dissolved, and an aqueous phase solution.

In this case, when particles for a display device are intended to be industrially produced in large quantities, it is required for securing manufacturability to prepare an oil phase solution in which carbon black is previously dispersed and to store this solution in a vessel (a pot) for a predetermined period of time.

However, once the solution has been prepared, the dispersibility of the carbon black therein tends to deteriorate gradually as time passes, although depending on the composition of the solution. In addition, a dispersion state of carbon black in particles for a display device, which is a factor affecting optical reflection density, is greatly influenced by the quality of a dispersion state of carbon black in the solution kept in a pot to be used in the mixing and stirring.

Thus, it is important that the dispersibility of carbon black in the solution immediately after the solution has been prepared is high, and additionally that the dispersibility of carbon black hardly deteriorates with time (a stable dispersion state is maintained for a long time), in other words, that a pot life is long.

The present inventors, as described above, consider that it is difficult to directly apply a conventional technology for improving the dispersibility of carbon black, which has been utilized for producing toner, to particles for a display device in view of the difference in utilization mode between toner used for forming an image and particles for a display device, and in view of manufacturability in the case of industrially producing particles for a display device, and as a result of earnest study, the following invention has been made.

A first aspect of the invention is to provide particles for a display device characterized by including carbon black having a pH of 3.5 or less and having a property of being able to be charged positively or negatively, which particles are produced by at least mixing and stirring an oil phase solution including the above-mentioned dispersed carbon black and a compound containing a nitrogen atom, and an aqueous phase solution.

A second aspect of the invention is to provide a method of producing particles for a display device, the method including at least mixing and stirring an oil phase solution including carbon black having a pH of 3.5 or less and a compound containing a nitrogen atom, and an aqueous phase solution.

A third aspect of the invention is to provide an image display medium including: at least a pair of substrates disposed so as to face each other, and at least two kinds of particles sealed into a void between the pair of substrates. At least one kind of the at least two kinds of particles has a property of being able to be positively charged and at least one other kind of the at least two kinds of particles has a property of being able to be negatively charged. The particles having a property of being able to be positively charged and the particles having a property of being able to be negatively charged have different colors from each other. Either the particles having a property of being able to be positively charged or the particles having a property of being able to be negatively charged are black particles including carbon black having a pH of 3.5 or less and are produced by at least mixing and stirring an oil phase solution including the carbon black and a compound containing a nitrogen atom, and an aqueous phase solution.

A fourth aspect of the invention is to provide an image forming apparatus for forming an image on an image display medium, the apparatus including the image display medium which includes: at least a pair of substrates disposed so as to face each other, and at least two kinds of particles sealed into a void between the pair of substrates. At least one kind of the at least two kinds of particles has a property of being able to be positively charged, and at least one other kind of the at least two kinds of particles has a property of being able to be negatively charged. The particles having a property of being able to be positively charged and the particles having a property of being able to be negatively charged have different colors from each other. Either the particles having a property of being able to be positively charged or the particles having a property of being able to be negatively charged are black particles including carbon black having a pH of 3.5 or less and are produced by at least mixing and stirring an oil phase solution including the carbon black and a compound containing a nitrogen atom, and an aqueous phase solution. The apparatus includes electric field-generating means for generating an electric field in accordance with an image between the pair of substrates.

As described above, the invention can provide particles for a display device which can increase optical reflection density in a black image display portion, a producing method thereof, an image display medium using these particles for a display device, and an image forming apparatus.

### BRIEF DESCRIPTION OF THE DRAWINGS

FIG. 1 is a schematic constitution view showing a first embodiment of an image forming apparatus of the present invention.

FIG. 2 is a schematic constitution view showing a second embodiment of an image forming apparatus of the invention.

FIG. 3 is a view showing a first example of a schematic cross-sectional view of an image forming portion (an image display medium 10) on an arbitrary plane of an image forming apparatus 12 shown in FIG. 2.

FIG. 4 is a view showing a second example of a schematic cross-sectional view of an image forming portion (an image display medium 10) on an arbitrary plane of an image forming apparatus 12 shown in FIG. 2.

FIG. 5 is a view showing a third example of a schematic cross-sectional view of an image forming portion (an image display medium 10) on an arbitrary plane of an image forming apparatus 12 shown in FIG. 2.

FIG. 6 is a schematic constitution view showing a third embodiment of an image forming apparatus of the invention.

FIGS. 7A to 7C are schematic views showing a pattern of a printing electrode.

FIG. 8 is a schematic constitution view of a printing electrode.

FIG. 9 is a schematic constitution view showing a fourth embodiment of an image forming apparatus of the invention.

FIG. 10 is a view showing an electric potential in an electrostatic latent image holding member and an opposite electrode.

### DETAILED DESCRIPTION OF THE INVENTION

Particles for a display device, a producing method thereof, an image display medium using the particles for a display device, and an image forming apparatus of the invention are hereinafter detailed.

(Particles for a Display Device and a Producing Method Thereof)

Particles for a display device of the invention include carbon black having a pH of 3.5 or less and having a property of being able to be charged positively or negatively. These particles for a display device are produced by at least mixing and stirring an oil phase solution including the dispersed carbon black and a compound containing a nitrogen atom (hereinafter, sometimes referred to as a nitrogen-containing compound), and an aqueous phase solution.

In the case of displaying a black image by an image display medium utilizing particles for a display device of the invention, optical reflection density thereof can be increased.

[Constitution of Particles for a Display Device of the Invention]

Particles for a display device of the invention include at least black colorant (namely, carbon black), a nitrogen-containing compound and resin. A charge controlling agent may be contained therein, and the colorant may serve as a charge controlling agent. Components of particles for a display device of the invention are detailed hereinafter.

-Nitrogen-Containing Compound-

A nitrogen-containing compound used for producing particles for a display device of the invention has a function of having affinity with carbon black and improving the dispersibility of carbon black in an oil phase solution. A nitrogen-containing compound has a high ability to continue to stably maintain a dispersion state of carbon black in an oil phase solution, whereby it becomes possible to achieve a long pot life, which enables to produce the storage of an oil phase solution required for industrially producing particles for a display device.

This nitrogen-containing compound is not particularly limited as far as the compound contains at least one nitrogen atom in its molecule. A compound containing an amino group is preferable. An amino group has a high ability to have affinity with acidic carbon black having a particularly high pH as described later, and thereby can further improve the dispersibility of carbon black in particles for a display device as well as the dispersibility and the dispersing storability thereof in an oil phase solution used for producing particles for a display device. In addition, an amino group has a function of further improving the charging property of particles for a display device. An amino group may be any bonding mode of primary to tertiary amine and may be contained by two or more in a molecule thereof.

A nitrogen-containing compound preferably contains a reactive group allowing the formation of an intermolecular bond to another molecule. Such a reactive group can form an intermolecular bond to a molecule existing around carbon black, and thereby can further improve the dispersibility of carbon black in particles for a display device as well as the dispersibility and the dispersing storability thereof in an oil phase solution used for producing particles for a display device.

Specific examples of such a reactive group include a functional group containing a polymerizable double bond such as monovalent acrylate and monovalent methacrylate and allowing the formation of an intermolecular bond to another molecule, and are not limited thereto.

The size (molecular weight) of a nitrogen-containing compound is not particularly limited, and is preferably low molecular weight so as to coat the surface of carbon black with high density with a large amount of nitrogen-containing compounds.

A nitrogen-containing compound employed in the invention more preferably contains both of an amino group and a reactive group in its molecule. Such a nitrogen-containing compound is described below by referring to a nitrogen-containing compound containing one amino group and one reactive group as represented by the following formula (1) as a specific example, and a nitrogen-containing compound employed for the invention is not limited only to the specific example represented by the following formula (1):

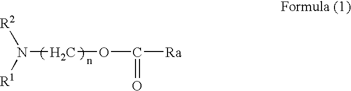

In the formula (1), n denotes an integer of 0 or more, preferably 1 to 8, and more preferably 1 to 3. Ra denotes a reactive group, specific examples of which include the above-described reactive groups.

R¹ and R² include a hydrogen atom and an alkyl group, and the structure of a group represented by R¹ and the structure of a group represented by R² may be the same or different.

In the case where R¹ and R² are alkyl groups, a carbon number thereof is preferably 1 to 10, and particularly preferably 1 or 2 (namely, a methyl group or an ethyl group).

Specific examples of a nitrogen-containing compound represented by the above-mentioned formula (1) include diethylaminoethyl acrylate, dimethylaminoethyl acrylate, dimethylaminoethyl methacrylate and diethylaminoethyl methacrylate in the case where Ra is monovalent acrylate or monovalent methacrylate and R¹ and R² are alkyl groups.

-Colorant (Carbon Black)-

Acidic carbon black having a pH of 3.5 or less (so-called acidic carbon black) is used as black colorant, namely, carbon black contained in particles for a display device of the invention. Acidic carbon black, in a broad sense, signifies carbon black having a pH of 6 or less in measuring the pH of suspension after boiling carbon black and pure water; however, it is required to use acidic carbon black having a pH of 3.5 or less in the invention. In the case of using acidic carbon black of a pH more than 3.5, the dispersibility and the dispersing storability thereof in an oil phase solution used for producing particles for a display device are rendered so insufficient as to consequently deteriorate the dispersibility of carbon black in particles for a display device.

Accordingly, from such a viewpoint, the pH of acidic carbon black used in the invention is required to be 3.5 or less, preferably 3.1 or less and more preferably 2.8 or less. The lowest limit value in pH of acidic carbon black is not particularly limited, preferably 2 or more in view of material availability (in the description hereinafter, ‘acidic carbon black’ signifies carbon black having a pH of 3.5 or less).

It is preferred that at least acidic carbon black and a nitrogen-containing compound are contained in an oil phase solution used for producing particles for a display device, and practically resin (including the case of existing as a monomer which is a precursor) is preferably contained therein. In this case, the quantity of acidic carbon black added to an oil phase solution is preferably 3 to 20 parts by weight, and more preferably 4 to 10 parts by weight based on 100 parts by weight of resin. In the case where the added quantity is less than 3 parts by weight based on 100 parts by weight of resin, the coloring of particles for a display device obtained by producing this oil phase solution is rendered so insufficient as occasionally not to increase optical reflection density of a black image to be displayed. Meanwhile, in the case where the added quantity is more than 20 parts by weight based on 100 parts by weight of resin, the concentration of acidic carbon black in an oil phase solution is so high as to occasionally deteriorate the dispersibility and the dispersing storability of carbon black in an oil phase solution.

The added quantity of acidic carbon black contained in particles for a display device is preferably 1 to 60% by weight, and more preferably 5 to 50% by weight. In the case where the added quantity of acidic carbon black contained in particles for a display device is less than 1% by weight, the coloring of particles for a display device is rendered so insufficient as occasionally not to increase optical reflection density of a black image to be displayed. Meanwhile, in the case where the added quantity is more than 60% by weight, it is required to prepare an oil phase solution containing a high concentration of carbon black, in which case, however, it is occasionally difficult to prepare an oil phase solution superior in the dispersibility and the dispersing storability of carbon black.

Examples of acidic carbon black having a pH of 3 or less to be used for the invention include commercial products such as “trade name: MA7, MA8, MA11, MA100, MA220, #1000, #2200B, #2350, #2400B and #2650, manufactured by Mitsubishi Chemical Industries, trade name: MOGUL L, REGAL 400R, MONARCH 1000, M1300 and Black pearls 1300, manufactured by Cabot Corporation, and trade name: 1035, 1040, 1255 and 3500 of RAVEN series, manufactured by Columbian Chemicals Company”.

The particle diameter of acidic carbon black is preferably 25 nm or less, and more preferably 20 nm or less. In the case where the particle diameter is more than 25 nm, acidic carbon black can occasionally be so nonuniformly dispersed into particles for a display device produced by using this oil phase solution as to deteriorate optical reflection density of a black image displayed by using these particles for a display device.

In addition, the DBP absorption quantity of acidic carbon black is preferably 94 (cm³/100 g) or less, and more preferably 65 (cm³/100 g) or less. In the case where the DBP absorption quantity is more than 94 (cm³/100 g), a polymerization reaction is performed in emulsion obtained by mixing and stirring an oil phase solution including a monomer as a precursor component of resin and a nitrogen-containing compound having a polymerizable reactive group and an aqueous phase solution, and then phase inversion of these polymerizable components is caused so as to solidify the total emulsion into a creamy state, whereby particles for a display device can occasionally not be produced.

The optical reflection density of acidic carbon black itself is desirably 1.35 or more from the viewpoint of visibility. In the case where the optical reflection density of acidic carbon black itself is less than 1.35, the black density in displaying an image is occasionally observed to be thinner.

-Resin-

Examples of resin composing particles for a display device of the invention include a homopolymer and a copolymer of monomers, such as styrenes such as styrene and chlorostyrene, monoolefins such as ethylene, propylene, butylene and isoprene, vinyl esters such as vinyl acetate, vinyl propionate, vinyl benzoate and vinyl butyrate, α-methylene aliphatic monocarboxylates such as methyl acrylate, ethyl acrylate, butyl acrylate, dodecyl acrylate, octyl acrylate, phenyl acrylate, methyl methacrylate, ethyl methacrylate, butyl methacrylate and dodecyl methacrylate, vinyl ethers such as vinyl methyl ether, vinyl ethyl ether and vinyl butyl ether, and vinyl ketones such as vinyl methyl ketone, vinyl hexyl ketone and vinyl isopropenyl ketone.

Particularly typical examples of resin include polystyrene, a styrene-alkyl acrylate copolymer, a styrene-alkyl methacrylate copolymer, a styrene-acrylonitrile copolymer, a styrene-butadiene copolymer, a styrene-maleic anhydride copolymer, polyethylene and polypropylene. Further, examples thereof include polyester, polyurethane, epoxy resin, silicone resin, polyamide, modified rosin and paraffin wax.

In addition thereto, examples thereof include polyvinyl resins such as polyolefin, polystyrene, acrylic resin, polyacrylonitrile, polyvinyl acetate, polivinyl alcohol, vinyl chloride and polyvinyl butyral; a polyvinyl chloride-acetate copolymer; a styrene-acrylic acid copolymer; straight silicon rosin including an organosiloxane bond, and modification thereof; fluororesins such as polytetrafluoroethylene, polyvinyl fluoride and polyvinylidene fluoride; polyester, polyurethane and polycarbonate; amino resin; and epoxy resin. These may be used singly or in a mixture of plural resins.

The above-described resins may be used as cross-linked. Further, resins to be used include binder resins known as a main component for toner used for a conventional electrophotographic method. In particular, resin containing a cross-linking component is preferably used.

-Other Addition Agents-

In addition to colorant (acidic carbon black), a nitrogen-containing compound and resin, other components and addition agents can be used for particles for a display device of the invention as required.

For example, a charge controlling agent may be added to particles for a display device of the invention in order to control charging property.

Examples of a charge controlling agent to be used include those used for toner materials for electrophotograph, such as cetyl pyridyl chloride, quaternary ammonium salt such as “trade name: P-5 1 and P-53, manufactured by Orient Chemical Industries, Ltd.”, salicylic acid-based metallic complex, phenol-based condensate, tetraphenyl-based compound, metal oxide particulates, or surface treated metal oxide particulates by various kinds of coupling agents.

The added quantity of a charge controlling agent is preferably 0.1 to 10% by mass, and more preferably 0.5 to 5% by mass. With regard to the size thereof, a charge controlling agent to be used preferably has a volume-average particle diameter of 5 μm or less, and more preferably has a volume-average particle diameter of 1 μm or less. A charge controlling agent may exist in particles for a display device in a mutually dissolved state.

A charge controlling agent desirably has colorlessness, low coloring power or the same type color as color of the total added particles for a display device. The impact on a hue of selected particles can be reduced by using a charge controlling agent having colorlessness, low coloring power or the same type color as color of the total added particles for a display device (namely, the same type color as color of the colorant contained in particles for a display device).

Here, ‘colorlessness’ signifies no color and ‘low coloring power’ signifies less influence on color of the total contained particles. ‘The same type color as color of the total added particles for a display device’ is black in itself (namely, color of carbon black) or a hue similar thereto, and consequently signifies less influence on color of the total added particles for a display device. In any case, it is preferred that color of particles for a display device is sufficient black whether a charge controlling agent has ‘colorlessness’, ‘low coloring power’ or ‘the same type color as color of the total added particles’.

Polymer particulates are preferably added to particles for a display device of the invention. Polymer particulates include a conventionally known polymer, preferably a polymer having a lower specific gravity than colorant used together therewith, and preferably a polymer selected properly in consideration of color of colorant used together therewith in the case where polymer particulates themselves have color. In addition, a resin to be used therewith includes the resins mentioned below, preferably methacrylic or acrylic resin.

Specific examples of polymer particulates include polystyrene resin, polymethyl methacrylate resin, urea formalin resin, styrene-acrylic resin, polyethylene resin and polyvinylidene fluoride resin, which can be used singly or in a combination of plural resins; and polymer particulates are not limited thereto. These resins preferably have a cross-linking structure, and more preferably have a higher refractive index than resin phase used together therewith.

Polymer particulates to be used are particulates having a spherical, indefinite or flat shape, and more preferably a spherical shape.

The volume-average particle diameter of polymer particulates to be used is shorter than that of particles for a display device, preferably 10 μm or less and more preferably 5 μm or less. The particle size distribution thereof is preferably sharp, and more preferably monodisperse.

In addition, a part or the total of polymer particulates preferably include hollow particles from the viewpoint of producing particles for a display device having a lower specific gravity. The volume-average particle diameter of hollow particles to be used is shorter than that of particles for a display device, preferably 10 μm or less and more preferably 5 μm or less. In the case of hollow particles, particularly, the volume-average particle diameter is further more preferably 0.1 to 1 μm, and particularly preferably 0.2 to 0.5 μm from the viewpoint of the scattering of light.

Here, ‘hollow particles’ denote particles having voids therein. The voids are preferably 10 to 90%. ‘Hollow particles’ may be in a state of hollow capsules or in a state such that external walls of particles are porous.

Hollow particles allow the increase of whiteness degree and the amelioration of masking property while utilizing the scattering of light caused by the difference of refractive index at an interface between a resin layer of an outer shell portion and an air layer inside the particles with regard to a state of hollow capsules, or the difference of refractive index between external walls and voids with regard to a state such that external walls thereof are porous, whereby hollow particles are particularly preferably contained in white particles for a display device.

In particles for a display device of the invention, the added quantity of polymer particulates is preferably 1 to 40% by mass with regard to the total particles for a display device, and more preferably 1 to 20% by mass. In the case where the added quantity of polymer particulates is less than 1% by mass, an effect of the reduction of specific gravity by adding polymer particulates occasionally appear with difficulty. Meanwhile, in the case where the added quantity of polymer particulates is more than 40% by mass, the manufacturability such as dispersibility occasionally deteriorates in producing particles for a display device.

A resistance controlling agent is preferably further added to particles for a display device of the invention. The addition of a resistance controlling agent allows quick charge exchange between particles and the achievement of early stabilization of a display image. Here, a resistance controlling agent signifies electro-conductive fine powders, particularly preferably electro-conductive fine powders such as to properly cause charge exchange and a leakage of charge. The coexistence of a resistance controlling agent enables to avoid the increase of the charge quantity of particles, so-called charge up, by long-term interparticle friction and friction between particle-substrate surfaces.

Appropriate examples of a resistance controlling agent include inorganic fine powders having a volume resistivity of 1×10⁶ Ωcm or less, preferably 1×10⁴ Ωcm or less. Specific examples thereof include tin oxide, titanium oxide, zinc oxide, iron oxide and particulates coated with various kinds of electro-conductive oxides, such as titanium oxide coated with tin oxide. A resistance controlling agent preferably has colorlessness, low coloring power or the same type color as color of the total contained particles. The significance of these terms is the same as described in a charge controlling agent. The added quantity of a resistance controlling agent has no problem if even in a range of not preventing color of coloring particles, preferably approximately 0.1 to 10% by mass.

The particle diameter of particles for a display device of the invention is not unqualifiedly determined; however, in order to obtain a favorable image, the volume-average particle diameter is preferably approximately 1 to 100 μm, and more preferably approximately 3 to 30 μm. The particle size distribution is preferably sharp, and more preferably monodisperse.

[A Method of Producing Particles for a Display Device]

Particles for a display device of the invention are produced by utilizing a wet-type producing method such as suspension polymerization, emulsion polymerization and dispersion polymerization. Specific examples thereof are not particularly limited if a method including at least mixing and stirring an oil phase solution as described previously in which at least carbon black having a pH of 3.5 or less and a nitrogen-containing compound are dispersed and an aqueous phase solution. Mother particles capable of finally being particles for a display device are formed from emulsion obtained at mixing and stirring an oil phase solution and an aqueous phase solution (so-called, emulsifying step).

An oil phase solution to be used for a method of producing particles for a display device of the invention is a solution in which at least carbon black having a pH of 3.5 or less and a nitrogen-containing compound are dispersed, and practically the solution preferably contains a monomer as a resin component composing particles for a display device and as required may contain various kinds of addition agents such as a charge controlling agent and a solvent for dissolving a monomer and a nitrogen-containing compound.

This oil phase solution may be prepared by mixing and stirring with the use of ball milling after mixing the above-described various kinds of components. A dispersion state of acidic carbon black immediately after being prepared is stably maintained over a long time by the function of a nitrogen-containing compound, so that a pot life of the oil phase solution is long. This long pot life enables to produce the storage of the oil phase solution in the case of industrially producing particles for a display device in large quantities. As a result, a flexible production and a good control of the quality variation of particles for a display device become possible.

A wet-type producing method as described in JP-A No. 10-10775 is preferably utilized in order to control a shape of particles for a display device. This wet-type producing method is a method such that resin is dissolved in a solvent and further an oil phase composition to which colorant is added is dispersed into an aqueous medium (aqueous phase) under the presence of an inorganic dispersant so as to form particles, utilizing a so-called suspension polymerization method, and such that suspension polymerization is performed by adding a not polymerizable organic solvent mutually dissoluble with a monomer (mutually indissoluble or less dissoluble with a solvent) so as to form particles and a drying method for removing the organic solvent is properly selected for drying these particles. Freeze-drying as described later is preferably utilized as this drying method.

An apparatus used for the emulsifying step is not particularly limited if a generally commercial emulsifier or disperser, and examples thereof include a batch type emulsifier such as “trade name: ULTRA-TURRAX, manufactured by IKA Japan K.K., trade name: POLYTRON, manufactured by KINEMATICA, trade name: T.K. AUTO HOMO MIXER, manufactured by Tokushu Kika Kogyo Co., Ltd. and trade name: NATIONAL COOKING MIXER, manufactured by Matsushita Electric Industrial Co., Ltd.”, a continuous type emulsifier such as “trade name: EBARA MILDER, manufactured by Ebara Corporation, trade name: T.K. PIPELINE HOMO MIXER and T.K. HOMOMIC LINE FLOW, manufactured by Tokushu Kika Kogyo Co., Ltd., trade name: colloid mill, manufactured by Shinko Pantec Co., Ltd., trade name: slasher and trigonal wet-type pulverizer, manufactured by MITSUI MIIKE CHEMIKAL INDUSTRY CO., LTD., trade name: CAVITRON, manufactured by Eurotec, Ltd. and trade name: FINE FLOW MILL, manufactured by Pacific Machinery & Engineering Co., Ltd.”, a batch-continuous dual type emulsifier such as “trade name: CLEAR MIX, manufactured by M technique Co., Ltd. and trade name: FILMICS, manufactured by Tokushu Kika Kogyo Co., Ltd.”, a high-pressure emulsifier such as “trade name: microfluidizer, manufactured by MIZUHO Industrial Co., Ltd., trade name: NANOMAKER and NANOMIZER, manufactured by Nanomizer and trade name: APV GAULIN, manufactured by Gaulin”, a film emulsifier such as “trade name: film emulsifier, manufactured by REICA Co., Ltd.”, a vibrating emulsifier such as “trade name: VIBROMIXER, manufactured by REICA Co., Ltd.”, and an ultrasonic emulsifier such as “trade name: ultrasonic homogenizer, manufactured by Branson Ultrasonics, Ltd.”

When producing particles for a display device of the invention by utilizing the emulsifying step, examples of an emulsifying assisting agent (dispersion stabilizer) to be used include a refractory fine powdery inorganic compound, such as refractory salts such as CaCO₃, BaSO₄, CaSO₄, MgCO₃, BaCO₃ and Ca(PO₄)₂; an inorganic high polymer such as diatomaceous earth, talc, silica and clay, and powders of metallic oxide. In addition, a water-soluble high polymer such as polyvinyl alcohol, gelatin and starch can be used together with the above-mentioned inorganic dispersion stabilizer.

With regard to these inorganic dispersion stabilizers, the surface of particles thereof is preferably coated with a polymer having a carboxyl group, and the coating enables the stable production of particles. A polymer having a carboxyl group to be used may have a number-average molecular weight of approximately 1000 to 200000 by VPO method.

Specific examples of a polymer having a carboxyl group to be used include acrylate resin, methacrylate resin, fumaric resin and maleic resin. Examples also include a homopolymer of acrylic acid, methacrylic acid, fumaric acid and maleic acid, which are monomers composing the above-mentioned resins, and a copolymer of these and other vinyl monomers. The carboxyl group may be a metallic salt such as sodium salt, potassium salt and magnesium salt.

These inorganic dispersion stabilizers to be used have an average particle diameter of 1 to 1000 nm, particularly preferably 5 to 100 nm. Also, these inorganic dispersion stabilizers to be used are preferably 1 to 500 parts by weight, and particularly preferably 10 to 300 parts by weight based on 100 parts by weight of particles for a display device.

A dispersion stabilizer to be used includes a polymeric dispersant. The polymeric dispersant is preferably hydrophilic, particularly preferably a polymeric dispersant having a carboxyl group and more preferably a polymeric dispersant further having a group, which is not a lipophilic group, such as a hydroxypropoxy group and a methoxy group. The specific polymeric dispersant includes carboxymethyl cellulose and carboxyethyl cellulose, particularly preferably carboxymethyl cellulose. The cellulose may have a degree of etherification of 0.6 to 1.5 and an average degree of polymerization of 50 to 3000. The carboxyl group may be a metallic salt such as sodium salt, potassium salt and magnesium salt. These polymeric dispersants to be used have a viscosity in an aqueous medium of 1 to 10000 mPa·s at a temperature of 20° C., and particularly preferably 1 to 2000 mPa·s.

In the above-described wet-type producing method, a solvent can be used as required for dissolving resin and a nitrogen-containing compound composing particles for a display device. The solvent is desirably a solvent which dissolves resin and does not mix with water, and examples thereof include an ester-based solvent such as methyl acetate, ethyl acetate, propyl acetate and butyl acetate, an ether-based solvent such as diethyl ether, dibutyl ether and dihexyl ether, a ketone-based solvent such as methyl ethyl ketone, methyl isopropyl ketone, methyl isobutyl ketone and cyclohexanone, a hydrocarbon solvent such as toluene and xylene, and a halogenated hydrocarbon solvent such as dichloromethane, chloroform and trichloroethylene. These solvents can preferably dissolve a polymer, in which solvents the rate of dissolution in water is approximately 0 to 30% by weight. The solvent is particularly preferably cyclohexane in consideration of safety, costs and also productivity on the occasion of industrially producing particles for a display device in large quantities.

In the case of using a solvent, the step of removing the solvent from emulsion is preferably provided after forming particles in the emulsion. In this step of removing a solvent, the solvent in emulsion is removed by freeze-drying in order to control the flocculation of particles formed in the emulsion. Freeze-drying can be performed in a range of −10 to −200° C., preferably −30 to −180° C. Also, freeze-drying is performed at a pressure of 40 Pa or less, particularly preferably 13 Pa or less.

Further, drying treatment may be applied to particles produced by the above-described wet-type producing method. Any known dryers may be used in this drying treatment; examples thereof include a vacuum dryer, a paddle dryer, a vibration fluid dryer, a tube dryer, a tray dryer, a pneumatic dryer such as a flash dryer. A pneumatic dryer such as a flash dryer is preferably used for drying particles in a short time.

Particles obtained by drying can be utilized directly also as particles for a display device, and the particle size distribution can be controlled by classifying operation. Examples thereof include various kinds of vibrating sieves, an ultrasonic sieve, an air separator, a wet-type sieve, a rotor rotating classifier employing the principle of centrifugal force and a pneumatic classifier, and are not limited thereto. These can desirably control the particle size distribution by using singly or in a combination of a multitude thereof. In the case of controlling particularly precisely, a wet-type sieve is preferably used.

In the above-described wet-type producing method, also heat treatment for obtained particles can be appropriately performed in order to render shapes of the particles uniform.

The following methods can be also utilized as a method of rendering uniform the shapes of particles obtained by not merely a wet-type producing method but conventionally known melt-kneading, pulverizing and classifying processes as well: a method of applying mechanical impact force (such as “trade name: HYBRIDIZER, manufactured by Nara Machinery Co., Ltd., trade name: ANGMILL, manufactured by Hosokawamicron Corporation and trade name: θCOMPOSER, manufactured by Tokuju Corporation”) to the particles, a method of heating the particles and a method of flocculating and rendering coalescent smaller particles so as to be enlarged to a desirable particle diameter as described in JP-A No. 2000-292971.

(An Image Display Medium and an Image Forming Apparatus)

An image display medium of the invention includes at least a pair of substrates disposed so as to face each other and a particle group including at least two kinds of particles sealed into a void between the pair of substrates, in which at least one kind of the above-mentioned at least two kinds of particles has a property of being able to be positively charged and at least one other kind thereof has a property of being able to be negatively charged and the above-mentioned particles being able to be charged positively and negatively have different colors from each other, and particles charged to either polarity of the above-mentioned particles being able to be charged positively and negatively include particles for a display device of the invention (namely, black particles).

Accordingly, with regard to an image display medium of the invention, the formation of a black image by these black particles can increase optical reflection density in a black image display portion and easily make the optical reflection density into 1.20 or more.

-Particle Group Including Two Kinds or More of Particles-

With regard to a particle group including two kinds or more of particles to be used for an image display medium of the invention, at least one kind thereof (first particles) has a property of being able to be positively charged and at least one other kind thereof (second particles) has a property of being able to be negatively charged, and the above-mentioned particles being able to be charged positively and negatively have different from each other.

In the above description, the expression is employed on the presupposition that first particles positively charged and second particles negatively charged are each one kind; however, both of them may be each one kind or two kinds or more (hereinafter, a generic name of first particles and second particles, namely, both particles being able to be charged positively and negatively is occasionally referred to as ‘display particles’).

In an image display medium of the invention, it is preferable that one of display particles is black, while the other is white. In other words, display particles except black preferably contains white colorant. The coloring power and density contrast of black particles can be improved by rendering white the display particles except black. Then, titanium oxide is preferable as white colorant for rendering white the particles except black. In the case where polymer particulates are used in the display particles as described above, the use of hollow particles as these polymer particulates allows whiteness degree to be further increased and a higher contrast to be anticipated.

With regard to an image display medium of the invention, display particles except black is not limited to white. It is required that display particles are adjusted so that one thereof has a property of being able to be positively charged and the other has a property of being able to be negatively charged, and when display particles are charged for the reason that particles of different kinds collide and are rubbed, one and the other are charged positively and negatively respectively in accordance with the relative position of charge sequences of both display particles. Thus, an appropriate selection of a charge controlling agent added to display particles allows the position of these charge sequences to be properly adjusted.

With regard to the granularity of display particles, an approximate equalization of white particles and black particles in particle diameter and distribution avoids an adhesion state such that large-diameter particles are surrounded by small-diameter particles, as a so-called two-component developer, whereby high white density and black density are obtained.

The coefficient of variation in particle size distribution of used display particles of two kinds is preferably approximately 15% or less, particularly preferably monodisperse. Small-diameter particles adhere to the periphery of large-diameter particles so as to occasionally decrease color density of the large-diameter particles in themselves. Contrast occasionally varies also with the mixture ratio of white and black particles. A desirable mixture ratio is an approximate equalization of the display particles in surface area. A large difference therefrom occasionally renders strong the color of particles predominant in the ratio.

-Substrate-

Substrates are a pair of substrates disposed so as to face each other and the above-mentioned display particles are sealed into a void between the pair of substrates. In the invention, a substrate is a platy body (an electro-conductive substrate) having electrical conductivity, and it is required for having a function as an image display medium that at least one of the pair of substrates is a transparent electro-conductive substrate. On the occasion, the transparent electro-conductive substrate is used as a display substrate.

An electro-conductive substrate may be a substrate which is electro-conductive in itself or a substrate such that the surface of an insulating support is treated for being rendered electro-conductive, and it does not matter whether crystalline or amorphous. Examples of an electro-conductive substrate such that a substrate is electro-conductive in itself include metals such as aluminum, stainless steel, nickel and chromium, alloy crystal thereof, and semiconductors such as Si, GaAs, GaP, GaN, SiC and ZnO.

Examples of an insulating support include macromolecular film, glass, quartz and ceramic. The treatment of an insulating support for being rendered electro-conductive can be performed while filming with the above-mentioned metals, which are included in the examples of an electro-conductive substrate such that a substrate is electro-conductive in itself, or gold, silver or copper by evaporation process, sputtering process and ion plating process.

A transparent electro-conductive substrate to be used is an electro-conductive substrate such that a transparent electrode is formed on one surface of an insulating transparent support or a transparent support having electrical conductivity in itself. Examples of a transparent support having electrical conductivity in itself include transparent electro-conductive materials such as ITO, zinc oxide, tin oxide, indium oxide, lead oxide and copper iodide.

Examples of an insulating transparent support to be used include transparent inorganic materials such as glass, quartz, sapphire, MgO, LiF and CaF₂, a film or a platy body of transparent organic resins such as fluororesin, polyester, polycarbonate, polyethylene, polyethylene terephthalate and epoxy, and additionally optical fiber, selfoc optical plate.

Examples used for the above-mentioned transparent electrode provided on one surface of a transparent support include an electrode formed with the use of transparent electro-conductive materials such as ITO, zinc oxide, tin oxide, indium oxide, lead oxide and copper iodide by evaporation process, ion plating process and sputtering process, or an electrode such that metals such as Al, Ni and Au are thinly formed into approximate translucence by evaporation process and sputtering process.

The opposing surfaces of these substrates affect the polarity of the above-mentioned charged particles, and thereby it is also a preferable mode to provide a protective layer in a state of an appropriate surface. A protective layer can be selected from the viewpoint of mainly adhesive properties to substrates, transparence, charge sequence and additionally low surface staining properties. Specific examples of a material for a protective layer include polycarbonate resin, vinyl silicone resin and fluorine group-containing resin. Resin is selected in view of a composition of the main monomer of used particles and a smaller difference in triboelectrification from the particles.

The formation of an image on an image display medium of the invention can be performed by utilizing an image forming apparatus including electric field-generating means for generating an electric field in accordance with an image between the pair of substrates composing the image display medium.

-Embodiments of Image Forming Apparatus of the Invention-

An image forming apparatus of the invention employing an image display medium of the invention is hereinafter detailed by referring to the drawings. The same numerical reference is assigned for members having the same function through the whole drawings and descriptions thereof are occasionally omitted.

-First Embodiment-

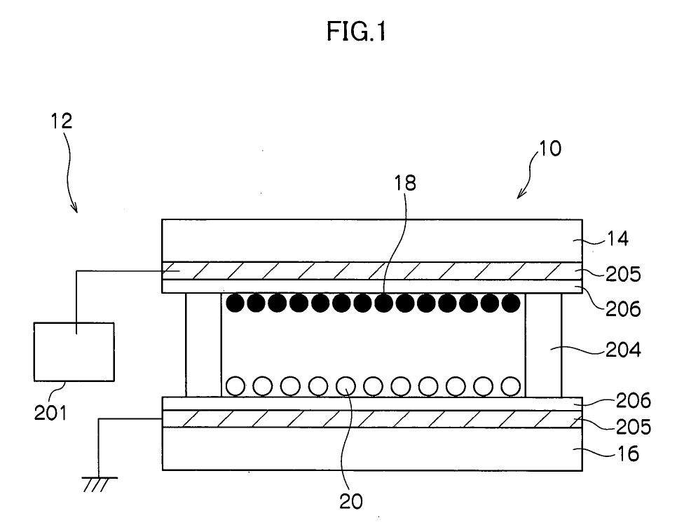

FIG. 1 is a schematic constitution view showing an example (a first embodiment) of an image forming apparatus of the invention.

An image forming apparatus 12 according to a first embodiment includes a voltage-applying means 201 as shown in FIG. 1. With regard to an image display medium 10, a spacer 204 is provided between a display substrate 14 on the side of an image to be displayed and a non-display substrate 16 opposed thereto so as to seal the outer periphery of these two substrates, and black particles 18 and white particles 20 are sealed as display particles into a void partitioned by the display substrate 14, the non-display substrate 16 and the spacer 204. Transparent electrodes 205 are provided as described later on opposing planes of the display substrate 14 and the non-display substrate 16, and the transparent electrode 205 provided on the opposing plane of the non-display substrate 16 is grounded, while the transparent electrode 205 provided on the opposing plane of the display substrate 14 is connected to the voltage-applying means 201.

Next, the image display medium 10 is detailed.

A 7059 glass substrate such that the size thereof is 50×50×1.1 mm and an ITO transparent electrode is provided as the transparent electrode 205 on the opposing plane thereof can be used for the display substrate 14 and the non-display substrate 16 composing the image display medium 10. Polycarbonate resin layers 206 (layers including polycarbonate resin (PC-Z) with a thickness of 5 μm) are provided on the surfaces of the transparent electrodes 205 provided on the opposing planes of the display substrate 14 and the non-display substrate 16.

A silicon rubber plate with the size of 40×40×0.3 mm, such that a square of 15×15 mm is cut out of the central portion thereof so as to form a space, can be utilized as the spacer 204.

On the occasion of producing the image display medium 10, this silicon rubber plate is placed on the opposing plane of the non-display substrate 16. Next, the spherical white particles 20 with a volume-average particle diameter of 20 μm containing titanium oxide and the spherical black particles 18 with a volume-average particle diameter of 20 μm containing carbon are mixed at a mass ratio of 2 to 1 as display particles, and approximately 15 mg of these mixture particles are sifted through a screen down to a cut-out square portion of the silicon rubber plate placed on the opposing plane of the non-display substrate 16. Thereafter, the opposing plane of the display substrate 14 is closely stuck to this silicon rubber plate so as to closely stick the silicon rubber plate and both of the substrates together by retaining while pressurizing both of the substrates with a double clip, whereby the image display medium 10 is formed. Particles for a display device of the invention are used as the black particles 18.

-Second Embodiment-

A second embodiment of the invention is hereinafter detailed by referring to the drawings.

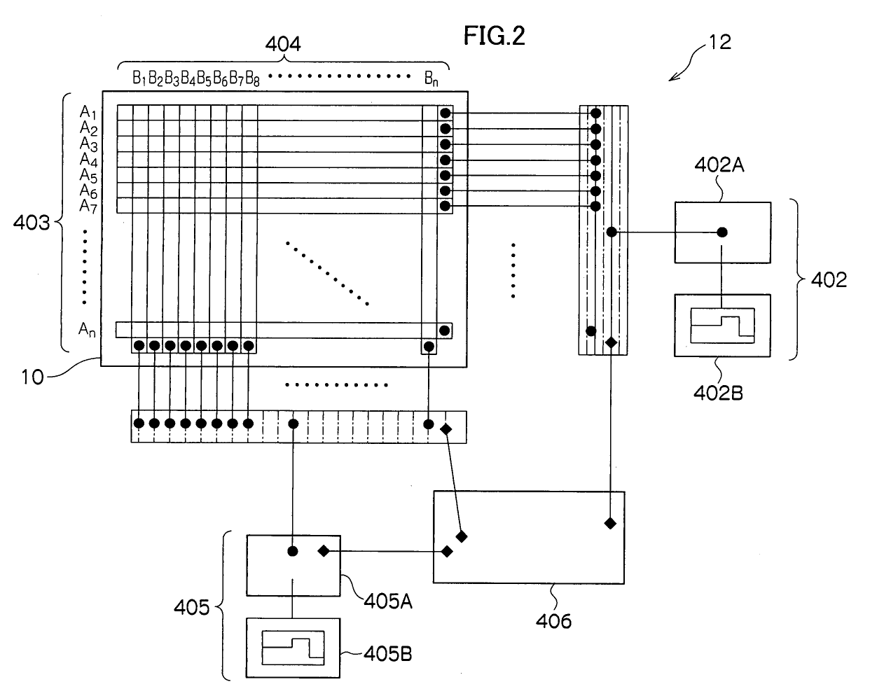

FIG. 2 is a schematic constitution view showing another example (a second embodiment) of an image forming apparatus of the invention and shows an image forming apparatus 12 for forming an image on an image display medium 10 employing a passive-matrix.

Electrodes 403An and 404Bn (n is a positive number) for controlling voltage in longitudinal and lateral directions are disposed in the image display medium 10, into which a plural display particle groups (not shown in the Fig.) of different charge polarities are sealed, in a planar direction thereof so as to be rendered a passive-matrix structure. The electrodes 403An are connected to a power supply 405A of an electric field-generating apparatus 405 composed of a waveform-generating apparatus 405B and the power supply 405A, while the electrodes 404Bn are connected to a power supply 402A of an electric field-generating apparatus 402 composed of a waveform-generating apparatus 402B and the power supply 402A. The electrodes 404Bn, the power supply 405A and the electrodes 403An are connected to a sequencer 406.

On the occasion of displaying an image, an electric potential is caused in each of the electrodes 403An and 404Bn by the electric field-generating apparatus 402 or the electric field-generating apparatus 405 so as to control the drive of voltage in each of the electrodes while controlling electric potential drive timing of the electrodes by the sequencer 406, whereby an electric field for driving display particles at each line is allowed to the electrodes 403A1 to An on one plane and an electric field in accordance with image data is simultaneously allowed to the electrodes 404B1 to Bn on the other plane.

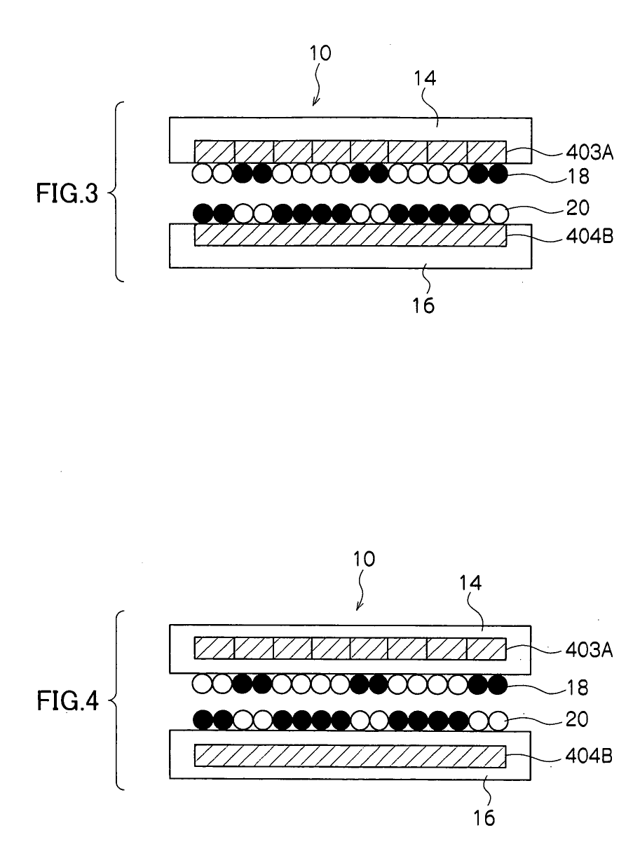

FIGS. 3 to 5 are views showing examples of a schematic cross-sectional view of an image forming portion (the image display medium 10) on an arbitrary plane of the image forming apparatus 12 shown in FIG. 2.

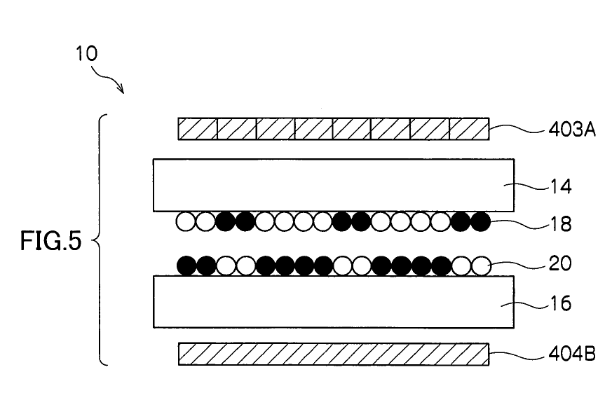

Display particles 18 and 20 contact with electrode planes or substrate planes, and at least one plane of a substrate 14 and a substrate 16 is transparent and can transmit color of the display particles 18 and 20 to the outside. The electrodes 403A and 404B may be integrally imbedded in opposing planes of the substrates 14 and 16 as shown in FIG. 3, integrally imbedded inside the substrates 14 and 16 as shown in FIG. 4, or provided separately from the display substrate 14 and the non-display substrate 16 at a position somewhat away from planes reverse to the opposing planes of the display substrate 14 and the non-display substrate 16 as shown in FIG. 5.

The proper setting of an electric field in the image forming apparatus 12 allows a display by passive-matrix drive. The display particles 18 and 20 can be driven if they have a threshold of movement by an electric field, and are not subject to limitations by charge polarity and charged quantity thereof.

-Third Embodiment-

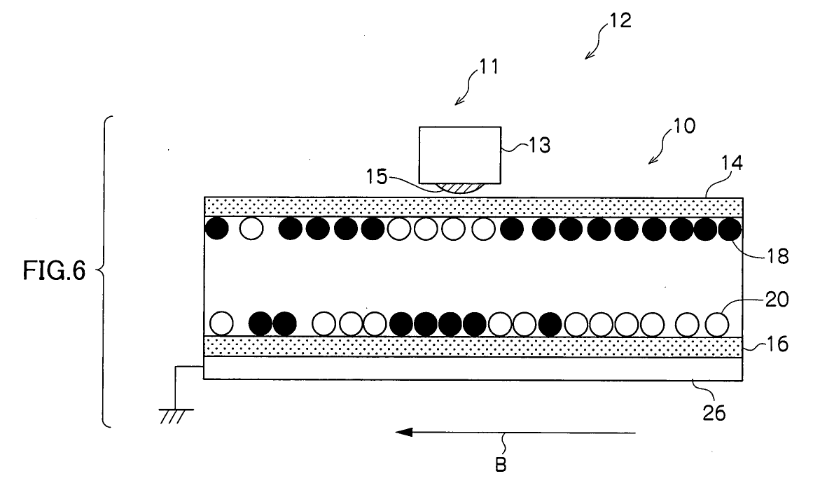

A third embodiment of the invention is hereinafter detailed by referring to the drawings. FIG. 6 is a schematic constitution view showing another example (a third embodiment) of an image forming apparatus of the invention and specifically shows an image forming apparatus employing a printing electrode.

An image forming apparatus 12 as shown in FIG. 6 is composed of a printing electrode 11 and an opposite electrode 26 connected to the ground and disposed so as to be opposed to this printing electrode.

An image display medium 10 can be conveyed between the printing electrode 11 and the opposite electrode 26 in the direction of an arrow B. The image display medium 10 is composed of a pair of substrates (a display substrate 14 and a non-display substrate 16) and display particles 18 and 20 sealed between these substrates, and is conveyed in the direction of an arrow B so that the non-display substrate 16 approaches or contacts with the opposite electrode 26 and the display substrate 14 approaches the printing electrode 11. The printing electrode 11 includes a substrate 13 and an electrode 15 provided on the display substrate 14 side of the substrate 13, and is connected to a power supply not shown in the Fig.

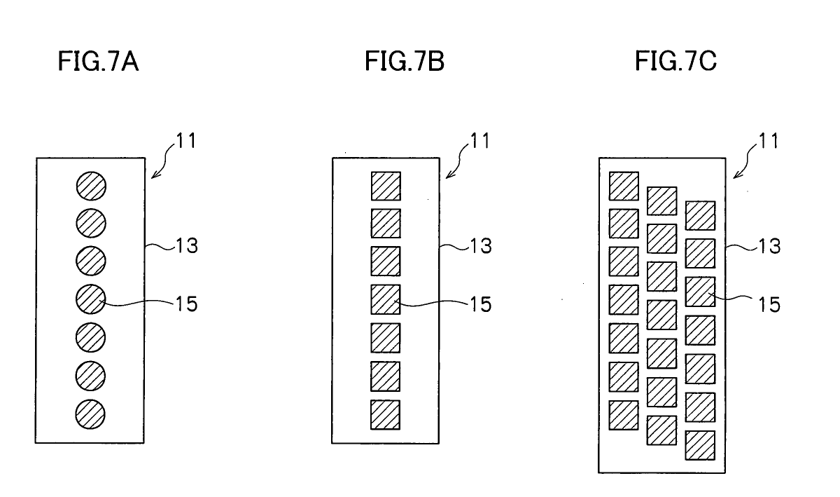

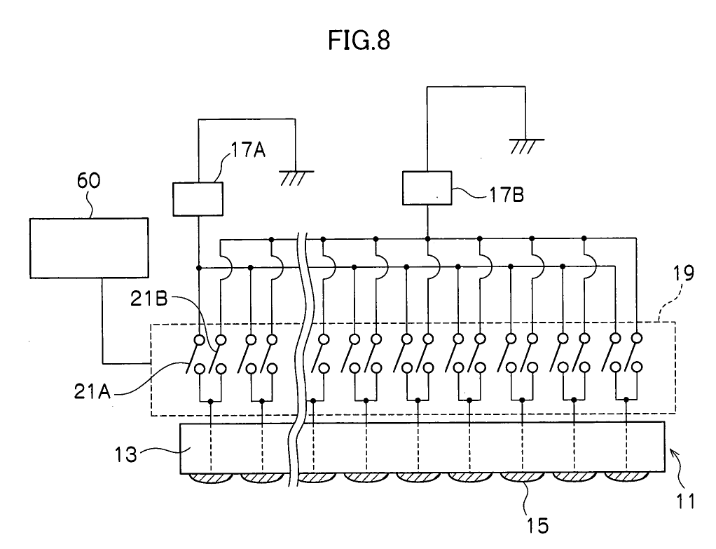

Next, the electrode 15 provided on the display substrate 14 side of the printing electrode 11 is described with regard to the disposition and shape. FIGS. 7A to 7C are schematic views showing an example of an electrode pattern provided in the printing electrode 11 and show the cases where a plane of the printing electrode 11, on which the electrode 15 is provided, is viewed from the non-display substrate 16 side to the direction of the display substrate 14 in FIG. 6.

The electrode 15, as shown in FIG. 7A, is arrayed so as to be opposed to a plane on one side of the display substrate 14 in a row at predetermined intervals in accordance with the resolution of an image along the direction (namely, the main scanning direction) approximately orthogonal to the direction (the direction of an arrow B in the Fig.) of conveying the image display medium 10. The electrode 15 may be a square as shown in FIG. 7B or disposed in a state of a matrix as shown in FIG. 7C.

Next, the printing electrode is detailed. FIG. 8 is a schematic constitution view of the printing electrode.

An AC power supply 17A and a DC power supply 17B are connected to each of the electrodes 15 through a connection control portion 19 as shown in FIG. 8. The connection control portion 19 is composed of plural switches including a switch 21A such that an end thereof is connected to the electrode 15 and the other end thereof is connected to the AC power supply 17A as well as a switch 21B such that an end thereof is connected to the electrode 15 and the other end thereof is connected to the DC power supply 17B. These switches 21A and 21B operate in on-off control by a control portion 60 so as to electrically connect the AC power supply 17A and the DC power supply 17B to the electrode 15. This makes it possible to apply alternating voltage, direct voltage or voltage such that alternating voltage and direct voltage are superposed.

Next, the function in a third embodiment is described.

First, when the image display medium 10 is conveyed between the printing electrode 11 and the opposite electrode 26 in the direction of an arrow B in the Fig. by a conveying means not shown in the Fig., the control portion 60 directs the connection control portion 19 to turn on all of the switches 21A. Thus, alternating voltage is applied to all of the electrodes 15 from the AC power supply 17A.

Here, the image display medium 10 is a medium in which two kinds or more of display particle groups are sealed into a space between a pair of substrates not having any electrodes. When alternating voltage is applied to the electrodes 15, the black particles 18 and the white particles 20 in the image display medium 10 reciprocate between the display substrate 14 and the non-display substrate 16. Thus, the black particles 18 and the white particles 20 are frictionally charged by the friction among the display particles and the friction between the display particles and the substrates, for example, the black particles 18 are positively charged, while the white particles 20 are not charged or negatively charged.

The white particles 20 are described below as negatively charged. Then, the control portion 60 directs the connection control portion 19 to turn on only the switches 21B corresponding to the electrodes 15 at a position in accordance with image data and to apply direct voltage to the electrodes 15 at a position in accordance with image data. For example, direct voltage is applied to a non-image portion, while direct voltage is not applied to an image portion. Thus, in the case where direct voltage is applied to the electrodes 15, the positively charged black particles 18 located in a part in which the printing electrode 11 is opposed to the display substrate 14 move to the non-display substrate 16 side by the function of an electric field as shown in FIG. 6. The negatively charged white particles 20 located on the non-display substrate 16 side move to the display substrate 14 side by the function of an electric field. Accordingly, only the white particles 20 appear on the display substrate 14 side, whereby an image is not displayed in a part corresponding to a non-image portion.

Meanwhile, in the case where direct voltage is not applied to the electrodes 15, the positively charged black particles 18 located in a part in which the printing electrode 11 is opposed to the display substrate 14 is maintained with no change on the display substrate 14 side by the function of an electric field. The positively charged black particles 18 located on the non-display substrate 16 side move to the display substrate 14 side by the function of an electric field. Accordingly, only the black particles 18 appear on the display substrate 14 side, whereby an image is displayed in a part corresponding to an image portion.

Thus, only the black particles 18 appear on the display substrate 14 side, whereby an image is displayed in a part corresponding to an image portion. In this manner, the black particles 18 and the white particles 20 move in accordance with an image, which is displayed on the display substrate 14 side. In the case where the white particles 20 are not charged, only the black particles 18 move under the influence of an electric field. The black particles 18 located in a part in which an image is not displayed move to the non-display substrate 16 side and are concealed from the display substrate 14 side by the white particles 20, so that an image can be displayed. Also after an electric field generated between the substrates of the image display medium 10 disappears, the displayed image is maintained by adhesive force characteristic of the display particles. These display particles can move again when an electric field is generated between the substrates; therefore, an image can be reiteratively displayed by the image forming apparatus 12. In such a manner, the display particles charged through the medium of air move by an electric field, whereby a high safety is brought. Air is low in viscous resistance and thereby can also satisfy a high-speed responsibility.

-Fourth Embodiment-

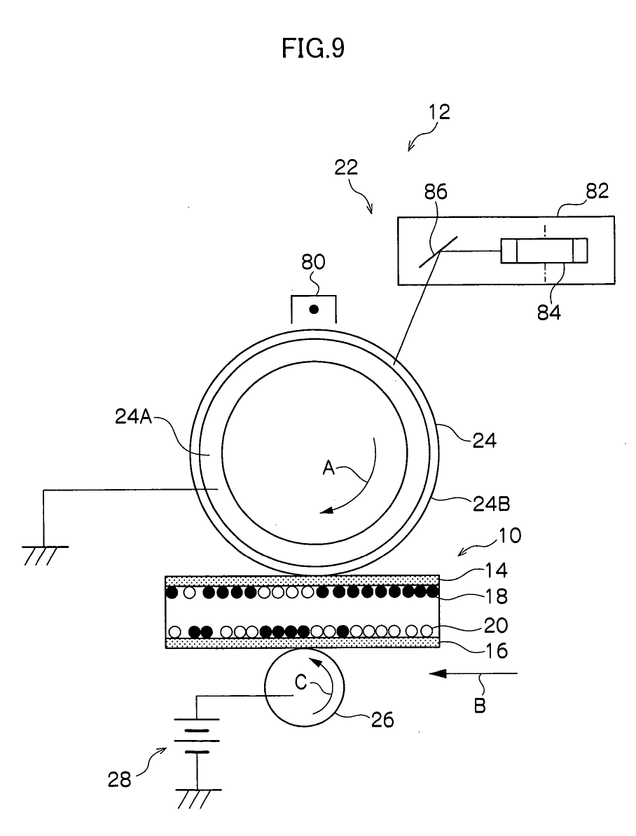

A fourth embodiment of the invention is hereinafter detailed by referring to the drawings. FIG. 9 is a schematic constitution view showing another example (a fourth embodiment) of an image forming apparatus of the invention and shows an image forming apparatus employing an electrostatic latent image holding member.

An image forming apparatus 12 as shown in FIG. 9 is composed mainly of a drum-shaped electrostatic latent image holding member 24 rotatable in the direction of an arrow A and a drum-shaped opposite electrode 26 rotatable in the direction of an arrow C and disposed so as to be opposed thereto, and an image display medium 10, in which display particles are sealed between a pair of substrates, can be inserted between the electrostatic latent image holding member 24 and the opposite electrode 26 in the direction of an arrow B.

A charging apparatus 80 is disposed on the approximately opposite side to the opposite electrode 26 in the periphery of the electrostatic latent image holding member 24 so as to approach the electrostatic latent image holding member 24, and a light-beam scanning apparatus 82 is disposed so that an electrostatic latent image can be formed on the surface of the electrostatic latent image holding member 24 in the direction of an arrow A of the charging apparatus 80. An electrostatic latent image forming unit 22 is composed of these three members. A photosensitive drum can be used as the electrostatic latent image holding member 24.

The photosensitive drum is such that a photoconductive layer 24B is formed on the outer periphery of a drum-shaped electro-conductive base 24A such as aluminum and SUS, and various known materials can be used as the photoconductive layer 24B; for example, inorganic photoconductive materials such as α-Si, α-Se and As₂Se₃, and organic photoconductive materials such as PVK/TNF, which materials can be formed by plasma CVD, evaporation process and dipping process.

A charge transport layer and an overcoating layer may be formed as required. The electro-conductive base 24A is grounded. The charging apparatus 80 uniformly charges the surface of the electrostatic latent image holding member 24 with a desirable electric potential. It is preferred that the charging apparatus 80 can charge the surface of the photosensitive drum with an arbitrary electric potential. The charging apparatus 80 to be employed in the embodiment is a corotron for uniformly charging the surface of the photosensitive drum by applying a high voltage to an electrode wire so as to cause corona discharge between the charging apparatus 80 and the electrostatic latent image holding member 24.

In addition thereto, various known charger can be used such as to charge the surface of the photosensitive drum by contacting electro-conductive roll members, brush and film members with the photosensitive drum to apply voltage thereto.

The light-beam scanning apparatus 82 forms an electrostatic latent image on the electrostatic latent image holding member 24 by irradiating the surface of the charged electrostatic latent image holding member 24 with a minute spotlight on the basis of picture signals. It is preferred that the light-beam scanning apparatus 82 forms an electrostatic latent image on the uniformly charged photosensitive drum by irradiating the surface of the photosensitive drum with a light beam in accordance with image data. The light-beam scanning apparatus 82 to be employed in the embodiment is an ROS (Raster Output Scanner) apparatus for photoscanning the surface of the photosensitive drum by a polygon mirror 84 while turning on and off a laser beam adjusted to a predetermined spot diameter in accordance with picture signals by an imaging optical system including the polygon mirror 84, a reflecting mirror 86, light source and lens not shown in the Fig. provided in the light-beam scanning apparatus 82. In addition thereto, an LED head such that LED is arrayed in accordance with a desirable resolution may be used.

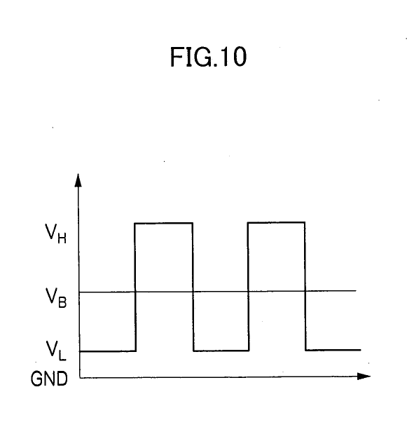

The opposite electrode 26 is composed of electro-conductive roll members having elasticity, and thereby can be more closely stuck to the image display medium 10. The opposite electrode 26 is disposed at an opposite position of the image display medium 10, which is conveyed in the direction of an arrow B in the Fig. by a conveying means not shown in the Fig., to the electrostatic latent image holding member 24. The opposite electrode 26 is connected to a direct voltage power supply 28. Bias voltage V_{B} is applied to the opposite electrode 26 by this direct voltage power supply 28. In the case where an electric potential in a positively charged part on the electrostatic latent image holding member 24 is rendered V_{H} and an electric potential in a not charged part is rendered V_{L}, this applied bias voltage V_{B} is rendered a voltage which is a medium electric potential therebetween, such as shown in FIG. 10.

Next, the function in a fourth embodiment is described.

When the electrostatic latent image holding member 24 starts to be rotated in the direction of an arrow A in FIG. 9, an electrostatic latent image is formed on the electrostatic latent image holding member 24 by the electrostatic latent image forming unit 22. Meanwhile, the image display medium 10 is conveyed between the electrostatic latent image holding member 24 and the opposite electrode 26 in the direction of an arrow B in the Fig. by a conveying means not shown in the Fig. Then, bias voltage V_{B} as shown in FIG. 10 is applied to the opposite electrode 26, and an electric potential of the electrostatic latent image holding member 24 is rendered V_{H} at an opposite position to the opposite electrode 26. Thus, in the case where an opposite part (a non-image portion) of the electrostatic latent image holding member 24 to a display substrate 14 is positively charged and black particles 18 adhere to an opposite part of the display substrate 14 to the electrostatic latent image holding member 24, the positively charged black particles 18 move from the display substrate 14 side to the non-display substrate 16 side so as to adhere to a non-display substrate 16. Consequently, only white particles 20 appear on the display substrate 14 side, whereby an image is not displayed in a part corresponding to a non-image portion.

On the other hand, in the case where an opposite part (an image portion) of the electrostatic latent image holding member 24 to a display substrate 14 is not positively charged and black particles 18 adhere to an opposite part of the non-display substrate 16 to the opposite electrode 26, an electric potential of the electrostatic latent image holding member 24 is rendered V_{L} at an opposite position to the opposite electrode 26, and thereby the charged black particles 18 move from the non-display substrate 16 side to the display substrate 14 side so as to adhere to the display substrate 14. Consequently, only the black particles 18 appear on the display substrate 14 side, whereby an image is displayed in a part corresponding to an image portion.

In this manner, the black particles 18 move in accordance with an image, which is displayed on the display substrate 14 side. Also after an electric field generated between the substrates of the image display medium 10 disappears, the displayed image is maintained by adhesive force characteristic of the particles and image-force between the particles and the substrates. The black particles 18 and the white particles 20 can move again when an electric field is generated between the substrates; therefore, an image can be reiteratively displayed by the image forming apparatus 12.

In such a manner, bias voltage is applied to the opposite electrode 26, so that the black particles 18 can move whether the black particles 18 adhere to the display substrate 14 or the non-display substrate 16. Thus, it is not required to previously stick the black particles 18 to one of the substrate sides. An image with high contrast and acutance can be formed. In addition, the particles charged through the medium of air move by an electric field, whereby a high safety is brought. Air is low in viscous resistance and thereby can also satisfy a high-speed responsibility.

Embodiments of an image forming apparatus of the invention employing an image display medium of the invention are described above by referring to the drawings; however, an image forming apparatus of the invention is not limited to these embodiments and can have a desirable constitution. The combination in color of the display particles is rendered black (namely, color of particles for a display device of the invention) and white; however, color of the display particles is not limited to this combination, and the white display particles can be properly replaced with display particles in other chromatic colors except black as required.

### EXAMPLES

The present invention is hereinafter described more specifically by referring to examples. However, the examples should not be construed to limit the scope of the invention.

(The Production of White Particles)

-Preparation of Dispersion A-

The following composition is mixed and ball milling is performed in a zirconia ball with 10 mmφ for 20 hours to prepare a dispersion A.

<Composition>

| | |
|---|---|
| Cyclohexyl methacrylate | 64 parts by mass |
| Titanium oxide (primary particle diameter 0.3 μm, | 30 parts by mass |
| “trade name: TIPAQUE CR63, manufactured by | |
| Ishihara Sangyo Kaisha, Ltd.”) | |
| Polymer particulates (hollow particles) (primary | 5 parts by mass |
| particle diameter 0.3 μm, “trade name: SX866(A), | |
| manufactured by JSR Corporation”) | |
| Charge controlling agent (“trade name: SBT-5-0016, | 1 part by mass |
| manufactured by Orient Chemical Industries, Ltd.”) | |

-Preparation of Dispersion B-

The following composition is mixed and fine grinding is performed in a ball mill in the same manner as the dispersion A to prepare a dispersion B.

<Composition>

| | |
|---|---|
| Calcium carbonate | 40 parts by mass |
| Water | 60 parts by mass |

-Preparation of Mixture C-

The following composition is mixed and deaeration is performed with an ultrasonic machine for 10 minutes to subsequently stir the composition with an emulsifier and prepare a mixture C.

<Composition>

| | |
|---|---|
| Dispersion B | 7.0 g |
| 20% sodium chloride aqueous solution | 50 g |

Next, 35 g of the dispersion A, 1 g of divinylbenzene and 0.35 g of a polymerization initiator “trade name: V601” (dimethyl2,2′-azobis2-methyl propionate, manufactured by Wako Pure Chemical Industries, Ltd.) are weighed and sufficiently mixed, and deaeration is performed with an ultrasonic machine for 10 minutes. This mixture is projected into the above-mentioned mixture C so as to be emulsified with an emulsifier. Subsequently, this emulsion is projected into a bottle to be stoppered with silicone, and thereafter vacuum deaeration is sufficiently performed by using a hypodermic needle and the bottle is filled with nitrogen gas. Next, the emulsion is reacted at a temperature of 70° C. for 10 hours to obtain particles. The obtained particulate powders are dispersed into ion exchange water to decompose calcium carbonate by hydrochloric acid water and filter the solution. Thereafter, the particulate powders are washed by sufficient distilled water to render granularity uniform with a nylon sieve having a sieve opening of 10 μm, 15 μm. This is dried so as to obtain white particles having an average particle diameter of 12.56 μm.

(The Production of Black Particles 1)

Black particles 1 are produced in the same manner as in producing the above-mentioned white particles except that the dispersion A is replaced by the following dispersion A1. The average particle diameter of the obtained black particles 1 is 12.5 μm.

-Preparation of Dispersion A1-

The following composition is mixed and ball milling is performed in a zirconia ball with 10 mmφ for 20 hours to prepare a dispersion A1.

<Composition>

| | |
|---|---|
| Methyl methacrylate | 87.2 parts by mass |
| Diethylaminoethyl methacrylate | 1.8 parts by mass |
| Carbon black (“trade name: #2650, manufactured | 10 parts by mass |
| by Mitsubishi Chemical Co., Ltd.”) | |
| Charge controlling agent (“trade name: COPY | 1 part by mass |
| CHARGE PSY VP2038, manufactured by Clariant | |
| Japan K.K.”) | |

(The Production of Black Particles 2)

Black particles 2 are produced in the same manner as in producing the above-mentioned white particles except that the dispersion A is replaced by the following dispersion A2. The average particle diameter of the obtained black particles 2 is 12.7 μm.

-Preparation of Dispersion A2-

The following composition is mixed and ball milling is performed in a zirconia ball with 10 mmφ for 20 hours to prepare a dispersion A2.

<Composition>

| | |
|---|---|
| Methyl methacrylate | 87.2 parts by mass |
| Diethylaminoethyl methacrylate | 1.8 parts by mass |
| Carbon black (“trade name: MA-100, | 10 parts by mass |
| manufactured by Mitsubishi Chemical Co., Ltd.”) | |
| Charge controlling agent (“trade name: COPY | 1 part by mass |
| CHARGE PSY VP2038, manufactured by Clariant | |
| Japan K.K.”) | |

(The Production of Black Particles 3)

Black particles 3 are produced in the same manner as in producing the above-mentioned white particles except that the dispersion A is replaced by the following dispersion A3. The average particle diameter of the obtained black particles 3 is 12.8 μm.

-Preparation of Dispersion A3-

The following composition is mixed and ball milling is performed in a zirconia ball with 10 mmφ for 20 hours to prepare a dispersion A3.

<Composition>

| | |
|---|---|
| Methyl methacrylate | 87.2 parts by mass |
| Diethylaminoethyl methacrylate | 1.8 parts by mass |
| Carbon black (“trade name: BLACK PEARLS L, | 10 parts by mass |
| manufactured by Cabot Corporation”) | |
| Charge controlling agent (“trade name: COPY | 1 part by mass |
| CHARGE PSY VP2038, manufactured by Clariant | |
| Japan K.K.”) | |

(The Production of Black Particles 6)

Black particles 6 are produced in the same manner as in producing the above-mentioned white particles except that the dispersion A is replaced by the following dispersion A6. The average particle diameter of the obtained black particles 6 is 12.8 μm.

-Preparation of Dispersion A6-

The following composition is mixed and ball milling is performed in a zirconia ball with 10 mmφ for 20 hours to prepare a dispersion A6.

<Composition>

| | |
|---|---|
| Methyl methacrylate | 87.2 parts by mass |
| Carbon black (“trade name: #2650, manufactured | 10 parts by mass |
| by Mitsubishi Chemical Co., Ltd.”) | |
| Charge controlling agent (“trade name: COPY | 1 part by mass |
| CHARGE PSY VP2038, manufactured by Clariant | |
| Japan K.K.”) | |

(The Production of Black Particles 7)

Black particles 7 attempt to be produced in the same manner as in producing the above-mentioned white particles except that the dispersion A is replaced by the following dispersion A7; however, the solution is rendered so creamy in polymerizing as not to obtain black particles.

-Preparation of Dispersion A7-

The following composition is mixed and ball milling is performed in a zirconia ball with 10 mmφ for 20 hours to prepare a dispersion A7.

<Composition>

| | |
|---|---|
| Methyl methacrylate | 87.2 parts by mass |
| Diethylaminoethyl methacrylate | 1.8 parts by mass |
| Carbon black (“trade name: ELFLEX 8, | 10 parts by mass |
| manufactured by Cabot Corporation”) | |
| Charge controlling agent (“trade name: COPY | 1 part by mass |
| CHARGE PSY VP2038, manufactured by Clariant | |
| Japan K.K.”) | |

(The Production of Black Particles 8)

Black particles 8 are produced in the same manner as in producing the above-mentioned white particles except that the dispersion A is replaced by the following dispersion A8. The average particle diameter of the obtained black particles 8 is 13.8 μm.

-Preparation of Dispersion A8-

The following composition is mixed and ball milling is performed in a zirconia ball with 10 mmφ for 20 hours to prepare a dispersion A8.

<Composition>

| | |
|---|---|
| Methyl methacrylate | 87.2 parts by mass |
| Carbon black (“trade name: MA-100S, | 10 parts by mass |
| manufactured by Mitsubishi Chemical Co., Ltd.”) | |
| Charge controlling agent (“trade name: COPY | 1 part by mass |
| CHARGE PSY VP2038, manufactured by Clariant | |
| Japan K.K.”) | |

(The Production of Black Particles 9)

Black particles 9 are produced in the same manner as in producing of the above-mentioned white particles except that the dispersion A is replaced by the following dispersion A9. The average particle diameter of the obtained black particles 9 is 12.8 μm.

-Preparation of Dispersion A9-

The following composition is mixed and ball milling is performed in a zirconia ball with 10 mmφ for 20 hours to prepare a dispersion A9.

<Composition>

| | |
|---|---|
| Methyl methacrylate | 87.2 parts by mass |
| Diethylaminoethyl methacrylate | 1.8 parts by mass |
| Carbon black (“trade name: #20, manufactured by | 10 parts by mass |
| Mitsubishi Chemical Co., Ltd.”) | |
| Charge controlling agent (“trade name: COPY | 1 part by mass |
| CHARGE PSY VP2038, manufactured by Clariant | |
| Japan K.K.”) | |

[Evaluation]

<Evaluation of a Pot Life>

With regard to dispersions A1 to A9 (oil phase solutions) used for producing black particles 1 to 9, which are obtained after being dispersed in a ball mill for a predetermined time, a dispersion state of the dispersions are visually observed after standing for 60 minutes since the preparation of the dispersions. The results are shown in Table 1. The results of evaluating shown in Table 1 are based on the following criteria.
◯: Dispersed.
×: Separated.

<Evaluation of Optical Reflection Density>

Next, an image display medium and an image forming apparatus having a constitution as shown in FIG. 1 are produced as described below by using the combination of white particles and black particles obtained as described above.

-Production of Image Display Medium/Apparatus-

A mixture of white particles and black particles at a mass ratio of 2:1 is sealed in a predetermined quantity into a void between opposing substrates (a display substrate 14 and a non-display substrate 16) so as to produce an image display medium 10 by a usual method, and further a printing electrode 11 is disposed in the vicinity of this image display medium 10 so as to produce an image forming apparatus 12. Kinds of the black particles used in each of examples and comparative examples are shown in Table 1.

-Measurement of Optical Reflection Density-

Next, when direct voltage of 100 V is applied to a transparent electrode 205 of the display substrate 14 of the image display medium 10, a part of negatively charged white particles 20 located on the non-display substrate 16 side start to move to the display substrate 14 side by the function of an electric field. When direct voltage of 200 V is applied thereto, many of the white particles move to the display substrate 14 side and display density is approximately saturated. Then, positively charged black particles move to the non-display substrate 16 side so as to display a black-and-white image. At that time, optical reflection density in a black image display portion is measured by a color reflection densitometer “trade name: X-RITE404A”. The results are shown in Table 1.

Thereafter, even when applied voltage is rendered 0 V, the particles on the display substrate do not move and the display density of a black-and-white image has no change.

TABLE 1

| | | Carbon Black | | | | | | | | |
|---|---|---|---|---|---|---|---|---|---|---|
| | | | | | | DPB | | | Evaluation | |
| | Black | | | | Particle | Absorption | | Success or | Optical | |
| | Parti- | | Trade | | Diameter | Quantity | Nitrogen-containing | Failure of | Reflection | Pot |
| | cles | Producer | Name | pH | (nm) | (cm³/100 g) | Compound | Polymerization | Density | Life |
| Example 1 | 1 | Mitsubishi | # 2650 | 2.8 | 13 | 64 | Diethylaminoethyl | ◯ | 1.37 | ◯ |
| | | Chemical Co., Ltd. | | | | | Methacrylate | | | |
| Example 2 | 2 | Mitsubishi | MA 100 | 3.1 | 22 | 93 | Diethylaminoethyl | ◯ | 1.37 | ◯ |
| | | Chemical Co., Ltd. | | | | | Methacrylate | | | |
| Example 3 | 3 | Cabot | Black | 2.4 | 24 | 62 | Diethylaminoethyl | ◯ | 1.35 | ◯ |
| | | Corporation | Peals I | | | | Methacrylate | | | |
| Comparative | 6 | Mitsubishi | # 2650 | 2.8 | 13 | 64 | Absent | X | Incapable to | X |
| Example 1 | | Chemical Co., Ltd. | | | | | | | be evaluated | |
| Comparative | 7 | Cabot Corporation | ELFLEX | 8.2 | 27 | 99 | Diethylaminoethyl | X | Incapable to | X |
| Example 2 | | | 8 | | | | Methacrylate | Rendered | be evaluated | |
| | | | | | | | | Creamy | | |
| Comparative | 8 | Mitsubishi | MS 100S | 3.5 | 22 | 100 | Absent | ◯ | 1.02 | X |
| Example 3 | | Chemical Co., Ltd. | | | | | | | | |
| Comparative | 9 | Mitsubishi | # 20 | 7.5 | 50 | 115 | Diethylaminoethyl | ◯ | 1.08 | X |
| Example 4 | | Chemical Co., Ltd. | | | | | Methacrylate | | | |

As shown in Table 1, it is confirmed that optical reflection density in any of examples is sufficiently higher than comparative examples 3 and 4 and that pot life of dispersions used for producing black particles is sufficient.

Meanwhile, it is confirmed in comparative examples that optical reflection density is insufficient and that the solution in polymerizing is solidified in a creamy state on the occasion of producing black particles and thereby the particles themselves can not be produced. It is understood that pot life of dispersions used for producing black particles is short and thereby the dispersions are not appropriate for industrial production in large quantities.

1. Particles for a display device comprising carbon black having a pH of 3.5 or less and having a property of being able to be charged positively or negatively,
wherein the particles are produced by at least mixing and stirring an oil phase solution comprising the carbon black and a compound containing a nitrogen atom, and an aqueous phase solution.

2. The particles for a display device of claim 1, wherein the compound containing a nitrogen atom comprises an amino group.

3. The particles for a display device of claim 1, wherein the compound containing a nitrogen atom comprises a reactive group.

4. The particles for a display device of claim 1, wherein the compound containing a nitrogen atom is represented by the following formula (1): 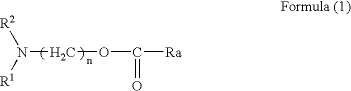
wherein n represents an integer of 0 or more, Ra represents a reactive group, and R¹ and R² each independently represent a hydrogen atom or an alkyl group.

5. The particles for a display device of claim 1, wherein the carbon black has a particle diameter of 25 nm or less.

6. The particles for a display device of claim 1, wherein the carbon black has a DBP absorption quantity of 94 (cm³/100 g) or less.

7. A method of producing particles for a display device, the method comprising at least mixing and stirring an oil phase solution comprising carbon black having a pH of 3.5 or less and a compound containing a nitrogen atom, and an aqueous phase solution.

8. The method of claim 7, wherein the compound containing a nitrogen atom comprises an amino group.

9. The method of claim 7, wherein the compound containing a nitrogen atom is represented by the following formula (1): 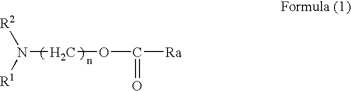
wherein n represents an integer of 0 or more, Ra represents a reactive group, and R¹ and R² each independently represent a hydrogen atom or an alkyl group.

10. An image display medium comprising:
at least a pair of substrates disposed so as to face each other; and
at least two kinds of particles sealed into a void between the pair of substrates,
wherein:
at least one kind of the at least two kinds of particles has a property of being able to be positively charged;
at least one other kind of the at least two kinds of particles has a property of being able to be negatively charged;
the particles having a property of being able to be positively charged and the particles having a property of being able to be negatively charged have different colors from each other; and
either the particles having a property of being able to be positively charged or the particles having a property of being able to be negatively charged are black particles comprising carbon black having a pH of 3.5 or less and are produced by at least mixing and stirring an oil phase solution comprising the carbon black and a compound containing a nitrogen atom, and an aqueous phase solution.

11. The image display medium of claim 10, wherein a black image displayed by the black particles has an optical reflection density of 1.20 or more.

12. The image display medium of claim 10, wherein the compound containing a nitrogen atom comprises an amino group.

13. The image display medium of claim 10, wherein the compound containing a nitrogen atom is represented by the following formula (1): 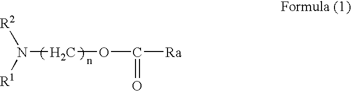
wherein n represents an integer of 0 or more, Ra represents a reactive group, and R¹ and R² each independently represent a hydrogen atom or an alkyl group.

14. An image forming apparatus for forming an image on an image display medium, the apparatus comprising the image display medium which comprises:
at least a pair of substrates disposed so as to face each other; and
at least two kinds of particles sealed into a void between the pair of substrates;
wherein:
at least one kind of the at least two kinds of particles has a property of being able to be positively charged;
at least one other kind of the at least two kinds of particles has a property of being able to be negatively charged;
the particles having a property of being able to be positively charged and the particles having a property of being able to be negatively charged have different colors from each other; and
either the particles having a property of being able to be positively charged or the particles having a property of being able to be negatively charged are black particles comprising carbon black having a pH of 3.5 or less and are produced by at least mixing and stirring an oil phase solution comprising the carbon black and a compound containing a nitrogen atom, and an aqueous phase solution,
the apparatus comprising electric field-generating means for generating an electric field in accordance with an image between the pair of substrates.

15. The image forming apparatus of claim 14, wherein the compound containing a nitrogen atom comprises an amino group.

16. The image forming apparatus of claim 14, wherein the compound containing a nitrogen atom is represented by the following formula (1): 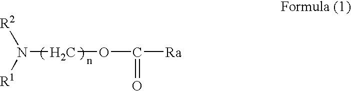
wherein n represents an integer of 0 or more, Ra represents a reactive group, and R¹ and R² each independently represent a hydrogen atom or an alkyl group.
